(19) United States
(12) Patent Application Publication
(10) Pub. No.: US 2006/0049158 A1
(43) Pub. Date: Mar. 9, 2006

(54) Method and apparatus for regulating an automatic treatment process

(75) Inventors: Bert Schurmann, Gernsbach (DE); Andreas Warth, Gaggenau (DE)

Correspondence Address: BIRCH STEWART KOLASCH & BIRCH, PO BOX 747, FALLS CHURCH, VA, 22040-0747, US

(73) Assignee: Precitec KG., Gaggenau-Bad Rotenfels (DE)

(21) Appl. No.: 11/201,128

(22) Filed: Aug. 11, 2005

(30) Foreign Application Priority Data
Aug. 13, 2004 (DE) 10 2004 039 410.5

(51) Int. Cl. B23K 26/03

(52) U.S. Cl. 219/121.83; 427/8

(57) ABSTRACT

The invention relates to a method and an apparatus for regulating an automatic treatment process. In order to ensure the desired quality of the treatment result and to improve it as compared with conventional methods, provision is made for a line of light (15) to be projected, by means of a light source (12) and first optics (13) arranged between the light source (12) and a workpiece (10) to be treated, onto a region of the workpiece (10) treated by means of a treatment head (24), for the line of light (15) to be projected onto a receiver arrangement (18) by second optics (17), and, by means of an evaluation circuit (22), for at least one treatment parameter of a treatment machine (23) to be regulated as a function of the comparison of an actual value of a parameter determined from the course of a profile with its desired value.

### BACKGROUND OF THE INVENTION

1. Field of the Invention

The invention relates to a method and an apparatus for regulating an automatic treatment process.

2. Description of the Prior Art

Nowadays, in industry and craft, a large number of treatment processes are carried out automatically by treatment machines and robots. Examples of this are welding and cutting of workpieces, in particular with appropriate high-power lasers, coating of workpieces with the aid of powder coating devices and the application of adhesives to joint surfaces of workpieces to be bonded to one another. During such treatment processes, the respective treatment heads of the treatment machines or robots are controlled in accordance with a treatment program, one or more operating parameters, such as treatment distance, feed speed and the like, additionally being regulated for the purpose of quality assurance.

For instance, DE 199 38 328 C2 discloses a method and an apparatus for the automatic application of a bead of adhesive to a joint surface of a workpiece, in which the bead of adhesive, i.e. a line of adhesive, is applied to the joint surface through an outlet opening of an applicator nozzle while the applicator nozzle is moved relative to the joint surface. In order to obtain the most uniform bead of adhesive, it is not only necessary that the application nozzle is moved with an appropriate feed speed with respect to the joint surface but also that the distance of the joint surface from the applicator nozzle is kept constant, apart from tolerances. For this purpose, the distance between the applicator nozzle and the joint surface is measured with the aid of a non-contact measuring method, for example inductively, capacitively or optically, so that, depending on the comparison of measured distance with its desired value, an actuating signal is generated, in response to which applicator nozzle and joint surface are moved in relation to each other such that the measured value of the distance between applicator nozzle and joint surface lies within a predefined, adjustable value range.

The position and the quantity of the adhesive applied can neither be monitored nor influenced with a method of this type.

### SUMMARY OF THE INVENTION

The invention is based on the object of providing a further method for regulating an automatic treatment process with which, in particular, the desired quality of a treatment result can be ensured and improved as compared with conventional methods. A further object of the invention is to provide an apparatus for carrying out such a method.

According to the invention, therefore, in a method for regulating and automatic treatment process, provision is made for a line of light to be projected onto a region of the workpiece treated by means of a treatment head, for the line of light to be projected onto a receiver device, for a profile of the workpiece surface in the region treated to be determined from the image of the line of light, and for at least one operating parameter to be regulated on the basis of a comparison of the actual value of a parameter determined from the course of the profile with a desired value.

In this way, the surface structure of a treated workpiece surface can therefore be registered in order, by using this structure, which is described by the course of the profile determined, to obtain information about the treatment result, from which the success of the treatment and therefore also the quality of the treatment can be derived.

If the surface structure determined indicates that the treatment result deviates from that desired, then this deviation can be used to determine an actuating signal for regulating a treatment parameter.

In order to achieve continuous regulation, provision is made for the line of light to be projected into a treated region of a workpiece which, with respect to a relative movement between workpiece and treatment head, is located close behind the treatment head and follows the movement of the treatment head.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows a simplified schematic illustration of a workpiece with a camera observing a surface region, in order to explain the method according to the invention;

FIG. 2 shows a simplified schematic illustration of an apparatus for registering the course of a profile in order to carry out the method according to the invention; and

FIG. 3 shows a simplified schematic block diagram of an apparatus according to the invention for regulating a treatment process in conjunction with a treatment machine, in particular with a robot for applying lines of material, in particular beads of adhesive.

### DETAILED DESCRIPTION OF THE PREFERRED EMBODIMENTS

In a particularly preferred embodiment of the invention, provision is made for the line of light to be projected onto the workpiece surface such that it is located both on the treated region and on a preferably linear workpiece structure which is independent of the workpiece treatment, intersecting a linear workpiece structure at the point at which a perpendicular from a central point of the treatment region onto the linear workpiece structure meets the latter.

In this way, it is not only possible to determine the surface of the workplace produced by the treatment process in the treatment region but also to determine the actual position of the treatment region on the workpiece.

In this case, the parameter determined from the course of the profile is preferably the distance between the treatment region, preferably a treatment line, seam or edge, and the preferably linear workpiece structure. It is therefore possible to intervene in a regulatory manner in the machine control such that the distance, apart from tolerances, is always the predefined distance between treatment region and reference structure of the workpiece. The registered parameter of the treatment result is therefore in this case at the same time the treatment parameter to be regulated.

In a first practical exemplary embodiment of the invention, provision is made for the treatment process to be regulated to be a welding process and for the line of light to be located transversely across the weld.

A second exemplary embodiment of the invention is distinguished by the fact that the treatment process to be regulated is a cutting process and that the line of light is located transversely across the cut line.

In a further embodiment of the invention, provision is made for the treatment process to be regulated to be an application of a material and for the line of light to be located transversely over at least one step between applied material and workpiece surface, it being possible for the material to be applied to be an adhesive, which is preferably applied as a line of adhesive or a bead of adhesive, or a powder for coating a workpiece surface.

In a particularly preferred development of the invention, the line of light is not only located close behind the treatment region in the treatment direction but also forms with the latter an angle different from 90°, the line of light being located obliquely over the treatment line such that it intersects a linear workpiece structure at the point at which a perpendicular from a central point of the treatment region onto the linear workpiece structure meets the latter.

In this way, the instantaneous distance of the treatment region from the workpiece structure can be determined, so that virtually delay-free regulation of this distance becomes possible.

In a preferred development of the invention, provision is further made for the parameter determined from the course of the profile to be a width and/or height or depth and/or cross-sectional area.

If, in particular in the case of material application, a cross-sectional area of the material applied is determined from the course of the profile, then this can be used to determine the quantity of material applied, so that provision can advantageously be made for the treatment parameter to be regulated to be a quantity of material applied.

Another development of the invention is distinguished by the fact that the treatment parameter to be regulated is a feed speed of the treatment head and/or is the distance between treatment head and workpiece.

The method according to the invention can preferably be carried out with an apparatus which comprises the following: a light source, first optics arranged between the light source and a workpiece to be treated, which project a line of light onto a region of the workpiece treated by means of a treatment head, second optics, which project the line of light onto a receiver arrangement, the optical axis of the second optics forming an angle with a projection direction of the first optics, and an evaluation circuit which registers the course of a profile from output signals from the receiver arrangement, from which an actual value of at least one parameter is determined, which circuit compares the actual value of the at least one parameter with its desired value and supplies to the treatment machine a signal for regulating at least one treatment parameter.

A line of light which is particularly narrow and at the same time nevertheless easily visible to the receiver arrangement respectively used can be generated if the light source is a laser diode and the first optics comprise a cylindrical lens for forming a fan beam.

The receiver arrangement is expediently a CCD matrix.

According to a preferred embodiment of the invention, provision is made for a camera to be provided which comprises the receiver arrangement and the second optics and which supplies pixel images.

In an expedient refinement of the invention, provision is made for the evaluation circuit to comprise an image processing unit for determining profiles, an evaluation unit for determining parameters, a comparison unit for comparing an actual value of at least one parameter with its desired value, and a control unit for determining and outputting an actuating signal to the treatment machine for the regulation of at least one treatment parameter.

In order to provide an operator, who sets up, programmes, monitors and/or services the treatment machine equipped with an apparatus according to the invention, with the possibility of observing the treatment operation or in order to facilitate the programming or the setting up of the machine, provision is further made for a display apparatus, in particular a monitor, to be provided for displaying processed or unprocessed images picked up by the receiver arrangement.

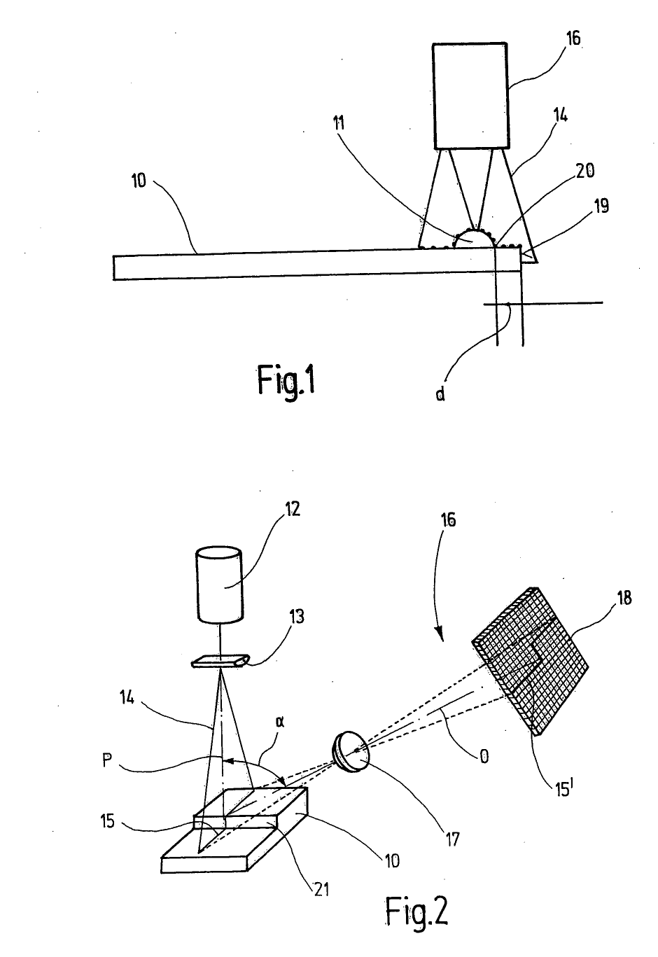

As illustrated purely schematically in FIG. 1, a line of adhesive 11 is applied to a workpiece 10 as a line of material and, in the following text, will be designated a bead of adhesive. A fan of light 14 produced by means of a light source, preferably a laser diode 12 and a cylindrical lens 13 serving as first optics (see FIG. 2) is projected onto the workpiece surface in the region of the bead of adhesive 11 applied, transversely with respect to the latter, in order to produce a line of light 15 there (as illustrated in FIG. 2).

The line of light 15 is observed by means of a camera 16 which, as illustrated in FIG. 2, comprises an objective 17 serving as second optics and a receiver arrangement 18, in order to register the course of a profile of the surface structure of workpiece 10 and bead of adhesive 11 close to a workpiece edge 19. From the course of the profile, which is indicated in FIG. 1 by a thick dotted line, both the edge 19 of the workpiece 10 and the edge 20 of the bead of adhesive placed toward the edge 19 can be detected three-dimensionally accurately, so that the distance d of the bead of adhesive 11 from the workpiece edge 19 can be calculated. In this way, an absolute measurement of the structure or geometry of the treated region is therefore made possible, systematic influences induced by the respective arrangement of line of light 15, objective 17 and receiver arrangement 18 also being taken into account by computation if necessary.

The measured value of the distance d between the edge 20 of the bead of adhesive 11 and the edge 19 of the workpiece 10 can then be compared with a desired value in order to determine an actuating signal which can be used for distance regulation, as will be explained in more detail further below.

FIG. 2 shows the production and observation of a line of light 15 on a workpiece 10 in more detailed form.

Although the production of the fan of light 14 with the aid of a laser diode 12 and a cylindrical lens arrangement 13 is preferred, any other suitable bright light source, for example a white or colored light-emitting diode with high luminosity, and any other suitable projection optics, for example rotationally symmetrical optics or cylindrical optics, can be used for imaging an illuminated gap.

In the exemplary embodiment illustrated according to FIG. 2, the fan of light 14 is projected onto the surface of the workpiece 10 such that its projection direction P is substantially perpendicular to the workpiece surface.

The camera 16 observes the line of light 15 obliquely from above, so that the optical axis O of the objective 17 forms an angle α with the projection direction P of the fan of light 14 which is greater than 0 and less than 90°, and which preferably lies in a range from about 20° to 60°, in particular between 30° and 40°. If the angle α between the projection direction P of the fan of light 14 and the optical axis O of the camera objective 17 is too small, the course of a profile will be registered which is very flat and therefore difficult to detect.

If the angle α is too large, the brightness of the projected line of light can become so low that the result is likewise difficulties in determining the course of the profile. Furthermore, a large angle α leads to a relatively large overall size if the line-of-light generator comprising laser diode 12 and cylindrical lens 13, together with the camera 16, is to be integrated in one housing.

Although, in principle, any receiver arrangement can be used in the camera 16 in order to produce an image of the line of light 15 which can be evaluated, it is preferred to use a CCD matrix, that is to say a CCD image sensor with a two-dimensional arrangement of photodiodes, so that the image produced by the receiver arrangement 18 is directly available in pixel form.

FIG. 2 further clearly reveals that a step 21 provided on the workpiece 10 produces a stepped image of the line of light 15. The height of the step can then be calculated absolutely, by taking into account the recording geometry, i.e. taking into account the projection direction of the fan of light 14, the direction of observation and the projection scale, from the pixel spacing of the two sections of the image of the line of light that run horizontally.

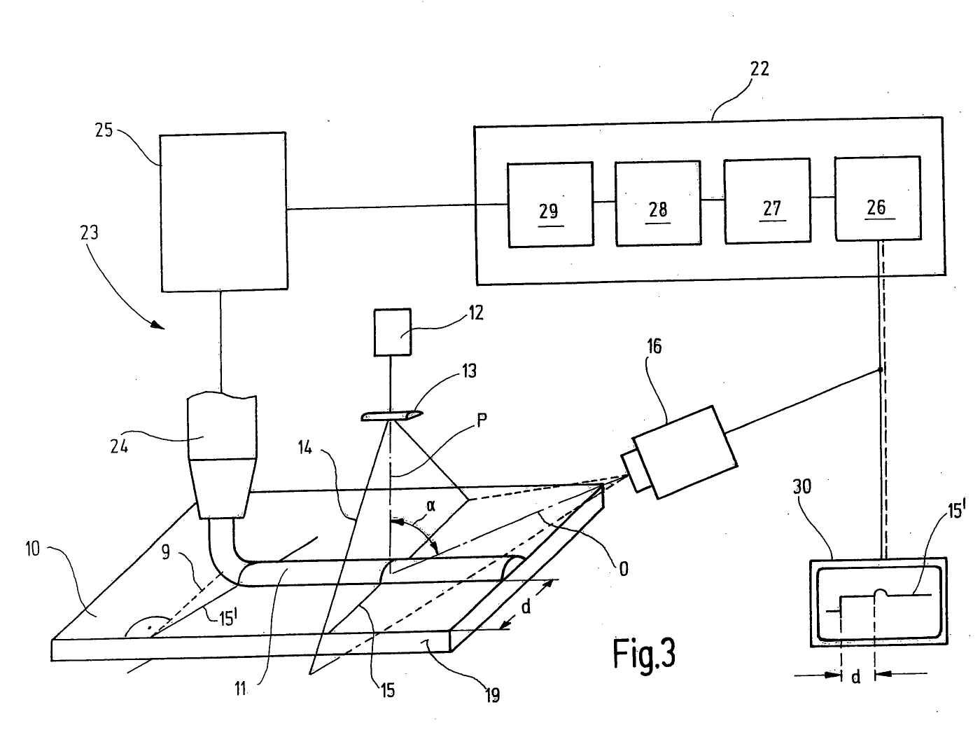

As FIG. 3 illustrates, an output of the camera 16 is connected to an evaluation circuit 22, to which the output signals from the receiver arrangement, i.e. the CCD matrix, are supplied. The evaluation circuit 22 uses the output signals to determine the course of a profile, from which an actual value of at least one parameter, that is to say for example the distance d of the bead of adhesive 11 from the edge 19 of the workpiece 10 or else the height of the bead of adhesive or its cross-sectional area, is determined, the actual value or values of the parameter or parameters to be monitored is or are then compared with its or their desired values, in order to output at least one actuating signal to a treatment machine 23 and in this way to regulate at least one treatment parameter.

As an example for a treatment machine 23 whose treatment process can be controlled by means of the method of the invention, a treatment machine 23 or a robot is illustrated which applies a line of material, in particular a bead of adhesive 11, to the surface of the workpiece 10 by means of an applicator head 24, which has an appropriate outlet opening. The applicator head 24 of the treatment machine 23 is guided over the workpiece 10 by a machine control system 25 as a function of appropriate control and regulating signals such that the bead of adhesive 11 assumes the desired position.

The line of light 15 produced by means of laser diode 12 and cylindrical lens 13 is illustrated transversely over the bead of adhesive 11 at a distance from the applicator head 24 in FIG. 3, for reasons of clarity. In practice, however, it should cross the bead of adhesive 11 or the respective treatment line as closely as possible behind the treatment region, in order to obtain the most delay-free regulation, as indicated in FIG. 3 by the line 15′. In this case, the line of light, as at 15, can form a right angle with the bead of adhesive 11 or the respective treatment line. In a preferred development of the invention, however, provision is made for the line of light, as at 15′, to be located at an angle to the bead of adhesive 11 or treatment line, in such a way that it intersects the edge 19 at the point at which the perpendicular 9 from the treatment point onto the edge 19 also meets the latter. In this way, the delay in regulation can be reduced to such an extent that it is virtually eliminated. “Treatment point” or “central point of the treatment region” is in this case to be understood in particular as the center of the treatment region, which is determined by a central axis of the treatment head, that is to say for example by the central axis of the line of adhesive emerging through an opening or, in the case of a laser treatment head, by the optical axis of the treatment beam.

If the workpiece structure to be followed represents a curved line, “perpendicular” is to be understood to be the shortest distance between treatment region or point and workpiece structure.

In order to evaluate the output signals from the camera 16, the evaluation circuit 22 preferably comprises an image processing unit 26, which uses the image data to determine the profile of the surface structure of the workpiece 10 in the region of the bead of adhesive 11 and the workpiece edge 19. From the course of the profile, an evaluation unit 27 then derives the desired parameters, that is to say for example the distance d between edge 19 and bead of adhesive 11 or else the height and/or the cross section of the bead of adhesive 11. The actual value or values of the parameter or parameters serving as controlled variables is or are then supplied to a comparison unit 28, which compares the actual value or values of the parameter or parameters with its or their desired values, in order to obtain corresponding control differences, which are then supplied to a control unit 29.

The control unit 29 then determines corresponding actuating signals, which are supplied to the machine control system 25 in order to regulate the treatment of the workpiece by means of the treatment head, that is to say the application of the bead of adhesive 11 to the workpiece surface by means of the applicator 24.

If, therefore, for example the distance d determined between bead of adhesive 11 and workpiece edge 19 is measured as a parameter or controlled variable, then this is compared with the desired distance and, if the measured distance is too great, the applicator head 24 is moved closer to the edge 19 of the workpiece 10, while in the case of a measured distance d that is too small, the applicator head is moved further away from the edge 19.

In addition, it is also conceivable to compare the cross section of the bead of adhesive 11 with a desired cross section, in order to determine whether the quantity of adhesive applied corresponds to the requirements. If the quantity of adhesive is too small, if therefore the measured cross section is too small, then it is conceivable, for example, to reduce the feed speed of the applicator head 24 or to increase the exit speed of the adhesive.

In order to make it easier for a person entrusted with looking after the treatment machine to set up or programme the machine for the treatment of a large number of identical workpieces, to monitor the treatment processes and, if appropriate, also to check the machine settings, a monitor 30 is provided to display the image 15′ of the line of light, which obtains the image signals either directly from the camera 16 or, as indicated by the dashed line, from the image processing unit 26 of the evaluation circuit 22. In the latter case, it is conceivable that the image data is subjected to suitable image processing for better visual display of the image 15′ of the line of light on the monitor 30.

The invention has hitherto been described by using a preferred exemplary embodiment, specifically a method for regulating automatic application of a bead of adhesive to a workpiece.

However, the invention is not restricted to the application of adhesive but can be used in all automatic treatment processes where the treatment process results in a change in the surface structure of the workpiece 10 after its treatment. In particular, the invention can also be used to control and regulate a welding process, the line of light then being located transversely across the weld, in order to determine its width and/or height and/or position relative to a linear structure on the workpiece surface. If the method according to the invention is used in a cutting process, for example in a laser cutting process, then the line of light is placed transversely across the cut line, that is to say over the linear gap forming in the workpiece.

Furthermore, the method according to the invention can also be used when coating workpiece surfaces, in particular during powder coating, when, for example, linear strips of material are applied one after another in the form of rows in order to obtain flat coatings.

In order to control the position of a treatment head relative to the workpiece, it is possible to use not only the workpiece edges but also other linear structures of the workpiece surface. For example, the linear workpiece structure can be an edging fold, a groove, a bead, a web, a step or the like.

The invention can also be used wherever a workpiece treatment results in a defined surface structure in a treated region of the workpiece, from which information about the characteristics of the treatment carried out can be determined.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method for regulating an automatic treatment process, in which
a line of light (15) is projected onto a region of a workpiece (10) treated by means of a treatment head (24),
the line of light (15) is projected onto a receiver arrangement (18),
a profile of the workpiece surface in the region treated is determined from the image of the line of light (15′), and
at least one operating parameter is regulated on the basis of a comparison of the actual value of a parameter determined from the course of the profile with its desired value.

2. The method as claimed in claim 1, wherein the line of light (15) is projected into a treated region of a workpiece which, with respect to a relative movement between workpiece (19) and treatment head (24), is located close behind the treatment head (24) and follows the movement of the treatment head (24).

3. The method as claimed in claim 1 or 2, wherein the line of light (15) is projected onto the workpiece surface such that it is located both on the treated region and on a preferably linear workpiece structure which is independent of the workpiece treatment.

4. The method as claimed in claim 3, wherein the workpiece structure is a workpiece edge (19), an edging fold, a seam, a bead, a web, a step or the like.

5. The method as claimed in claim 3, wherein the parameter determined from the course of the profile is the distance between the treatment region, preferably a treatment line, seam or edge, and the preferably linear workpiece structure, which is at the same time a treatment parameter to be regulated.

6. The method as claimed in claim 1, wherein the treatment process to be regulated is a welding process, and wherein the line of light (15) is located transversely across the weld.

7. The method as claimed in claim 1, wherein the treatment process to be regulated is a cutting process, and wherein the line of light (15) is located transversely across the cut line.

8. The method as claimed in claim 1, wherein the treatment process to be regulated is an application of a material, and wherein the line of light (15) is located transversely across at least one step between applied material and workpiece surface.

9. The method as claimed in claim 8, wherein the material to be applied is an adhesive, which is preferably applied as a line or bead of adhesive (11).

10. The method as claimed in claim 8, wherein the material to be applied is a powder for coating a workpiece surface.

11. The method as claimed in claim 6, wherein the line of light (15) forms an angle with the treatment line that is different from 90°.

12. The method as claimed in claim 11, wherein the line of light (15) is located obliquely across the treatment line in such a way that it intersects a linear workpiece structure at the point at which a perpendicular from a central point of the treatment region onto the linear workpiece structure meets the latter.

13. The method as claimed in claim 1, wherein the parameter determined from the course of the profile is a width and/or height or depth and/or cross-sectional area.

14. The method as claimed in claim 8 and as claimed in claim 11, wherein the treatment parameter to be regulated is a quantity of material applied.

15. The method has claimed in claim 1, wherein the treatment parameter to be regulated is a feed speed of the treatment head (24) and/or a distance between treatment head and workpiece.

16. An apparatus for regulating an automatic treatment process to be carried out by a treatment machine, comprising:
a light source (12),
first optics (13) arranged between the light source (12) and a workpiece (10) to be treated, which project a line of light (15) onto a region of the workpiece (10) treated by means of a treatment head (24),
second optics (17), which project the line of light (15) onto a receiver arrangement (18), the optical axis (O) of the second optics (17) forming an angle (α) with a projection direction (P) of the first optics (13), and
an evaluation circuit (22) which registers the course of a profile from output signals from the receiver arrangement (18), from which an actual value of at least one parameter is determined, which circuit compares the actual value of the at least one parameter with its desired value and supplies to the treatment machine (23) a signal for regulating at least one treatment parameter.

17. The apparatus as claimed in claim 16, wherein the light source is a laser diode (12).

18. The apparatus as claimed in claim 16 or 17, wherein the first optics comprise cylindrical optics (13) for forming a fan of light (14).

19. The apparatus as claimed in claim 16, wherein the receiver arrangement is a CCD matrix.

20. The apparatus a claimed in claim 16, wherein a camera (16) is provided which comprises the receiver arrangement (18) and the second optics (17) and which supplies pixel images.

21. The apparatus as claimed in claim 16, wherein the evaluation circuit (22) comprises
an image processing unit (26) for determining profiles,
an evaluation unit (27) for determining parameters,
a comparison unit (28) for comparing an actual value of at least one parameter with its desired value, and
a control unit (29) for determining and outputting an actuating signal to the treatment machine (23) for the regulation of at least one treatment parameter.

22. The apparatus as claimed in claim 16, wherein furthermore a display device, in particular a monitor (30), is provided for displaying a processed or unprocessed image picked up by the receiver arrangement (18).
